(19) United States
(12) Patent Application Publication
(10) Pub. No.: US 2016/0021285 A1
(43) Pub. Date: Jan. 21, 2016

(54) FOCUSING SYSTEM AS WELL AS CAMERA UNIT WITH A FOCUSING SYSTEM

(71) Applicant: iPEK INTERNATIONAL GMBH, Sulzberg (DE)

(72) Inventors: Andreas NADLER, Bodelsberg (DE); Gerhard KENNERKNECHT, Oberstdorf (DE)

(21) Appl. No.: 14/800,265

(22) Filed: Jul. 15, 2015

(30) Foreign Application Priority Data
Jul. 17, 2014 (DE) 20 2014 103 294.0

(51) Int. Cl. H04N 5/225; G02B 3/14; G03B 13/36

(52) U.S. Cl. CPC H04N 5/2256; G03B 13/36; G02B 3/14; H04N 2005/2255

(57) ABSTRACT

A focusing system is provided, in particular, for a camera unit of an inspection system, in particular, a pipe inspection system, comprising a distance measuring device for measuring a distance to an object, a control means operatively coupled to the distance measuring device, and an optical lens configured as liquid lens and operatively coupled to the control means, wherein the control means is adapted to adjust the focal distance of the liquid lens by means of the distance data received from the distance measuring device. Further, a camera unit comprising an imaging means and an inventive focusing system assigned to the imaging means, and an inspection system having an inventive camera unit are provided.

### CROSS REFERENCE TO RELATED APPLICATIONS

This application claims priority under 35 U.S.C. §119 to German Application No. 20 2014 103 294.0, filed on Jul. 17, 2014, the contents of which are incorporated by reference herein.

### TECHNICAL FIELD

The invention relates to a focusing system, in particular, for a camera unit of an inspection system, a camera unit, in particular, for an inspection system, with a focusing system according to the invention, as well as an inspection system with a camera unit according to the invention.

### BACKGROUND

For the visual inspection or examination of conduits, in particular, sewers, ducts, property drainage systems, seepage water pipes, or other sewage related plants, it is known to use so-called TV pipe inspection systems, which comprise a camera unit for taking pictures and/or moving images. The recorded image data can be transmitted to a control means disposed outside of the inspected conduit or pipe, and can be displayed there. For an optimal illustration of the observed surroundings or of an object present in the conduit, it is known to equip the camera unit with a focusing means in order to enable a sharp representation of the observed surroundings or of the observed object.

Hereby, it is, however, disadvantageous that frequent adaptation of the lens setting during the inspection procedure may lead to a substantial loss of time. In particular, during panning of the camera unit, it may be necessary to frequently adapt the focusing.

A further disadvantage is that the lens of the camera unit takes relatively much space, being specifically disadvantageous with respect to inspection systems for pipes having a small diameter. Further, inspection systems with large camera units are not suitable for inspecting other small cavities, for example, cavities or pipes in industrial plants or rotor blades of wind turbines.

Therefore, it is an object of the present invention to at least partially avoid the disadvantages mentioned above and to provide solutions, which, on the one hand, enable a simple, time-saving, or fast focusing, and, on the other hand, allow for a particularly space-saving configuration of the lens or the focusing means and thus, the entire inspection system, in order to be able to also inspect pipes or cavities, for example, in industrial plants or other plants, having a small diameter.

### SUMMARY

According to the invention, this object is solved by a focusing system, in particular, for a camera unit of an inspection system, having a camera unit with a focusing system according to the invention, as well as an inspection system with a camera unit according to the invention according to the independent claims. Preferred embodiments and further developments of the invention are defined in the respective dependent claims.

Accordingly, a focusing system is provided, in particular, for a camera unit of an inspection system, in particular, a pipe inspection system, comprising
a distance measuring device for measuring a distance to an object,
a control means operatively coupled to the distance measuring device, and
an optical lens configured as liquid lens and operatively coupled to the control means,
   wherein the control means is adapted to adjust or modify the focal distance of the liquid lens by means of the distance data received by the distance measuring device.

Thereby, a particularly space-saving lens is advantageously enabled, which besides an automatic focusing due to the short reaction time of the liquid lens, which may be less than 1 ms, also enables a particularly quick focusing. A quick focusing specifically is advantageous, if the inspection system advances within the sewage pipe and/or if the camera unit is panned, and thereby, the distance to the observed object frequently or even continuously changes. Thereby, it is specifically guaranteed that the object observed with the camera unit is focused at any point of time.

Between the control means and the liquid lens, a driver circuit may be arranged, which is coupled operatively to the control means and to the liquid lens. Thereby, the electrical voltages of up to 100 V or more required for the control of the electrical field of the liquid lens may be provided.

According to a preferred embodiment of the invention, the distance measuring device comprises an optical distance measuring device. The optical distance measuring device may comprise an infrared distance measuring device having at least one diode emitting infrared light and at least one infrared photodiode, in particular, a multi-element photodiode or lateral diode. Hereby, a contact-less and, in particular, quick measuring of the distance between the distance measuring device and an object is enabled.

According to an embodiment of the invention, it may be provided for the distance measuring device being arranged relative to the liquid lens such that the optical axis of the distance measuring device substantially runs parallel to the optical axis of the liquid lens. Moreover, hereby it is advantageous, if the distance of the optical axis of the distance measuring device to the optical axis of the liquid lens is as small as possible. Thereby, it is guaranteed as far as possible that the distance is measured to each point of the object, which lies on the optical axis or which lies close to the optical axis of the liquid lens.

According to a further embodiment of the invention, the distance measuring device may comprise a first distance measuring device and at least a second distance measuring device. Preferably, the at least one second distance measuring device is arranged spaced apart to the first distance measuring device. The optical axis of the first distance measuring device and the optical axis of the at least one second distance measuring device may substantially run parallel to the optical axis of the liquid lens.

Hereby, it is advantageous, if the control means is adapted to adjust or modify the focal distance of the liquid lens on the basis of the distance data received by the first distance measuring device and by the at least one second distance measuring device.

The control means, hereby, may be adapted to determine an average distance to the object from the distance data received from the first distance measuring device and from the at least one second distance measuring device, and to adjust or to modify, on the basis of the average distance, the focal distance of the liquid lens. Thereby, deviations of the distances between the distance measuring devices and the object to the distance between the liquid lens and the object may be compensated in an advantageous manner as far as possible such that an optimal focusing may also be guaranteed, if the distance between the distance measuring device and the object substantially differs from the distance between the liquid lens and the object.

According to a preferred embodiment of the invention, the focusing system may comprise a deflection means, which is adapted to deflect the optical path of the distance measuring device such that the latter is directed substantially coaxially to the optical axis of the liquid lens through the liquid lens. Thereby, the distance between the liquid lens and each point of the object, which lies on the optical axis of the liquid lens, may be measured in an advantageous manner, which in turn enables a specifically precise focusing.

The deflection means, hereby, may comprise a beam splitter, for example, a semi-transparent mirror, which is arranged in the optical axis of the liquid lens, and which is inclined by a certain angle with respect to the optical axis of the liquid lens. The deflection means, moreover, may comprise at least one deflection mirror.

According to an embodiment of the invention, the control means is adapted to adjust or to modify the focal distance of the liquid lens in real time. Thereby, it is guaranteed that during movement of the inspection system or upon a movement, for example, a panning of the camera unit, the observed object is displayed sharply also during the movement independently of the velocity of the movement.

The control means, further, may be adapted to take a horizontal offset between the liquid lens and the distance measuring device during adjustment of the focal distance of the liquid lens into account.

It is preferable, if the focal distance is automatically adjustable.

According to an embodiment of the invention, the focal distance may also be adjustable manually.

It is preferred, if the focusing system may be switched from a manual operation mode into an automatic operation mode for adjustment of the focal distance.

Further, a camera unit, in particular, for an inspection system, in particular, a pipe inspection system, is provided by the invention comprising an imaging means and a focusing system assigned to the imaging means according to the invention.

The imaging means may comprise a digital image sensor, in particular, a CCD image sensor or a CMOS image sensor.

The camera unit may comprise an illumination unit or an illumination unit may be assigned to the camera unit.

The illumination unit may comprise a number of illuminants, in particular, light emitting diodes, which are arranged radially around the liquid lens of the focusing system.

The illumination unit may comprise a ring, at which the illuminants and preferably at least one distance measuring device are arranged.

According to a preferred embodiment of the camera unit according to the invention, the camera unit may comprise a storage and/or a data processing means, or may be coupled to a storage and/or data processing means for storing or buffering the images taken by the camera unit.

Detection means may be assigned to the camera unit for detecting, if data can be transmitted between the camera unit and an external control means, whereby the detection means are adapted to signalize to the control means of the focusing system that no data can be transmitted between the camera unit and the external control unit, and wherein the control means is adapted to switch into an automatic operation mode for adjusting the focal distance of the liquid lens, if no data can be transmitted.

If, for example, the data transmission between the camera unit and an external control means operated by operating personnel is interrupted, thereby, it is guaranteed that the observed subject further is sharply imaged on the imaging means.

The camera unit, moreover, may be adapted to store the images taken in the storage and/or data processing means, if no data can be transmitted.

The storing or buffering of the images taken in combination with the automatic adjustment of the focal distance of the liquid lens has the advantage that the inspection system, for example, may also be advanced in the pipe to be inspected during an interruption of the data transmission, whereby it is ensured that the objects observed by the camera unit are imaged sharply.

Further, an inspection system is provided by the invention, which has a camera unit according to the invention. The camera unit may be arranged at a crawler of the inspection system pivotably. According to an alternative embodiment, the inspection system may be configured as a push system, at the front end of which a camera unit according to the invention is arranged.

The focusing system or the lens may be configured specifically space-savingly, enabling a particularly space-saving configuration of the camera unit such that also a specifically space-saving installation of the camera unit according to the invention into the inspection system is allowed.

### BRIEF DESCRIPTION OF THE DRAWINGS

Further details and features of the invention as well as concrete, in particular, preferred embodiments of the invention can be derived from the subsequent description in connection with the drawing, in which:

FIG. 1 shows an embodiment of the focusing system according to the invention;

FIG. 2 shows an exemplary embodiment of an inspection system according to the invention with a camera unit according to the invention arranged thereon;

FIG. 3 shows a concrete example of an inspection system according to the invention with a camera unit according to the invention arranged thereon;

FIG. 4 shows a camera unit according to the invention or a camera head with a distance measuring device arranged thereon of a focusing system according to the invention:

FIG. 5 shows a camera unit according to the invention in a front view;

FIGS. 6(a) and 6(b) show further developments of focusing systems according to the invention; and

FIG. 7 shows a further concrete example of an inspection system according to the invention with a camera unit according to the invention arranged thereon.

### DETAILED DESCRIPTION

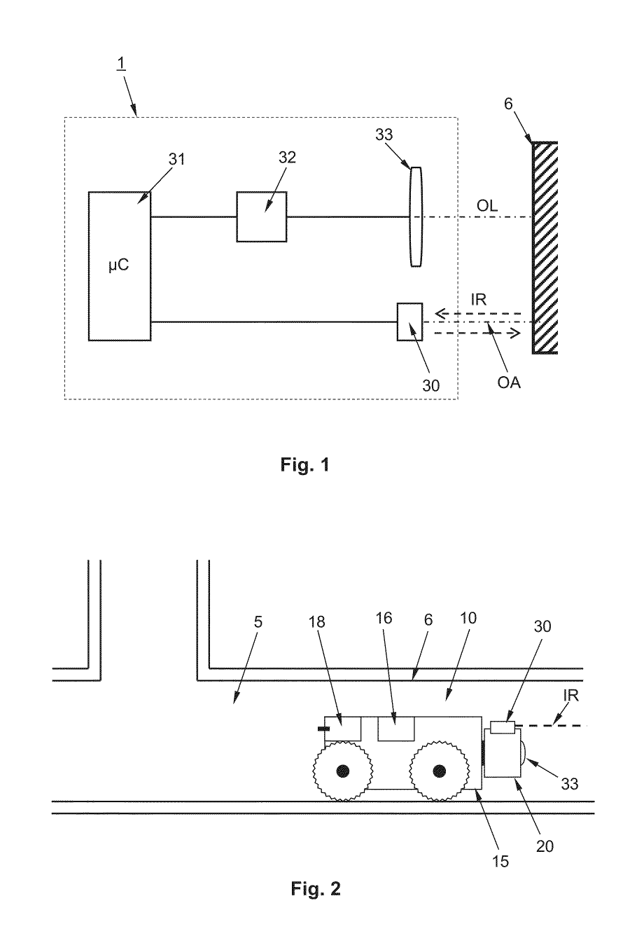

FIG. 1 shows a focusing system 1 according to the invention.

The focusing system 1 substantially comprises or has an optical lens embodied as liquid lens 33, a control means 31 embodied as a microcontroller, a distance measuring device 30, which may be embodied as optical distance measuring device, and a driver circuit 32. The liquid lens 33 is coupled to the driver circuit 32. The driver circuit 32, in turn, is coupled to the control means 31 via a digital bus. The distance measuring device 30 is also coupled to the control means 31 via a digital bus.

The control means or the microcontroller 31 and the distance measuring device 30 are configured such that the control means 31 may receive from the distance measuring device 30 distance data, or the control means 30 may determine from the data received from the distance measuring device distance data. The distance data indicate the distance between the distance measuring device 30 and an object 6 lying on the optical axis OA of the distance measuring device 30. The object, for example, may be a pipe wall or an inner wall of the pipe or an object being located within the pipe.

The control means 31 is adapted to adjust or to modify, by means of the distance data, the focal distance or the focus of the liquid lens 33 such that an object observed by a camera unit, which the liquid lens is assigned to, is imaged sharply. By means of the driver circuit 32, the electrical voltages required for the control of the electrical field of the liquid lens 33 are provided, wherein according to an embodiment of the invention, the driver circuit 32 may also be a component of the control means or may be integrated into the control means 31.

According to the invention, the distance measuring device 30 is configured as optical distance measuring device, in particular, as infrared distance measuring device. The infrared distance measuring device, here, may comprise an infrared light emitting diode and an infrared photo diode, for example, a multi-element photodiode or a lateral diode. The infrared light emitting diode, moreover, may be temperature compensated such that it is ensured that always the same amount of light is emitted within the pipe interior independently of the temperature in order to avoid measuring errors due to temperature fluctuations.

With respect to the embodiment of a focusing system 1 shown in FIG. 1, the liquid lens 33 is arranged relative to the distance measuring device 30 such that the optical axis OL of the liquid lens 33 substantially runs parallel to the optical axis of the distance measuring device 30. Moreover, the liquid lens 33 and the distance measuring device 30 are arranged relative to each other such that the distance between the optical axis OL of the liquid lens and the optical axis OA of the distance measuring device preferably is smaller or minimized. Thereby, it is ensured that the distance measuring device 30 measures the distance to a point of the object 6, which preferably lies close to that point of the object 6, which is located on the optical axis OA of the liquid lens 33. Therefore, it can be assumed that the distance between the distance measuring device 30 and the object 6 generally is almost identical to the distance between the liquid plants 33 and the object 6.

According to a further development of the invention, the focusing system may comprise one or more additional distance measuring devices not shown in FIG. 1, by means of which also a distance to the object 6 can be measured. The control means 31, hereby, may calculate an average value from the measured distances, and may, by means of this average value, i.e., mean distance, may adjust or modify the focal distance of the liquid lens 33. The mean distance, hereby, substantially corresponds to the distance between the liquid lens 33 and the object 6. Different distances of the object 6 to the individual distance measuring devices, which for example may arise due to an irregular surface of the object 6, may thus be compensated efficiently.

FIG. 2 shows a schematic illustration of an inspection system 10 according to the invention with a camera unit 20 arranged thereon.

The inspection system 10, here, comprises an inspection vehicle 15, at the front end of which the camera unit or the camera head 20 is arranged. Further, a distance measuring device 30 according to the invention is arranged at the camera unit 20. With respect to the example of an inspection system 10 according to the invention shown in FIG. 2, the latter is connected to a control unit not shown here arranged outside of the pipe via a transmission/receiver unit 18 for wireless data transmission. Via the transmission/receiver unit 18 measurement data, in particular, the image data taken by the camera unit as well as the distance data determined by the distance measuring device 30, may be transmitted to the control means wirelessly or control data may be received from the control means. The control data, for example, may comprise control commands, by means of which the camera unit can be controlled, for example, panned. Hereby, it is preferable that the focus or the focal distance of the liquid lens 33 is automatically adjustable by means of the focusing system 1 according to the invention such that at least for focusing, no control data have to be transmitted from a control means arranged outside of the sewer system to the inspection system.

According to an alternative embodiment, the inspection system 10 may also be coupled to a control unit arranged outside of the sewer system via an electric or data cable.

With respect to the embodiment of the inspection system shown in FIG. 2, it is provided for supplying the inspection vehicle 15 or the components arranged at the inspection vehicle 15 with energy from a battery or an accumulator such that an energy supply from the outside may be omitted. The inspection vehicle 15 may advance within the pipe 5 autonomously, if needed, wherein at the same time, it is ensured that the objects present in the range of vision of the camera unit 20 are imaged sharply.

Further, the camera vehicle 15 may comprise a storage means and/or a data processing means 16. In the storage means 16, image data taken by the camera unit 20 may be stored or buffered. A buffering of image data is specifically advantageous, if a data transmission between an external control unit and the inspection system 10 is not possible, for example, because a radio communication to the external control means is interrupted. The inspection vehicle 15 then is able to further advance within the pipe 5, and to thereby buffer the images taken by the camera unit in the storage means 16. Due to the automatic focusing by means of the focusing system 1, hereby, it is ensured that objects or motives which are located on the optical axis OL of the liquid lens 33 are imaged sharply in any case.

Further, it may be provided for the focusing system 1 being adapted to adjust or modify the focus or focal distance of the liquid lens in real time. Thereby, it is ensured that objects, which suddenly occur on the optical axis OL of the liquid lens 33 are imaged sharply without or nearly without a time lag. In particular during panning of the camera head or the camera unit 20, for example, towards the pipe wall 6, the distance between the liquid lens 33 and the point of the object 6 lying on the optical axis OL of the liquid lens 33 can change very quickly. By the adjustment or modification of the focal distance of the liquid lens in or nearly in real time, it is ensured that the object acquired by the camera unit 20 is imaged sharply during the entire panning procedure.

The camera unit 20 or the crawler 15 may comprise detection means or a sensor unit, which is adapted to determine, if a data transmission is possible between the inspection system and an external control unit. In case the detection means detects that a data transmission is not possible, for example, due to an interrupted radio connection, the detection means may signalize to the focusing system 1 that the control means 31 of the focusing system 1 is to be switched into an automatic operation mode, in which the focal distance of the liquid lens 33 is adjusted or modified automatically. At the same time, the detection means may instruct the camera unit or the inspection system 10 to buffer the image data taken thereafter in the storage means 16.

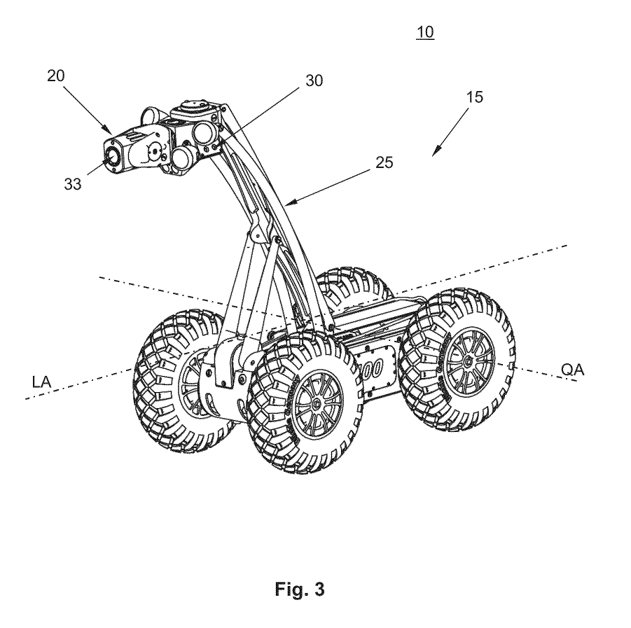

FIG. 3 shows a concrete example of an inspection system 10 according to the invention. The inspection system 10 comprises an inspection vehicle 15, which comprises a lifting unit 25, which may be pivoted forwards or backwards. According to a configuration not shown here, the lifting unit 25 also is pivotable laterally.

At the upper end of the lifting units 25, a camera unit 20 according to the invention is arranged as well as two distance measuring devices 30 of a focusing system according to the invention, wherein a first distance measuring device is arranged at the right-hand side and a second distance measuring device is arranged at the left-hand side of the camera head 20. According to the configuration shown here, the camera unit20 is rotatable about its longitudinal axis LA independently of the distance measuring devices 30. Further, the camera unit 20 is also pivotable relative to the lifting unit 25, whereby then, the distance measuring devices 30 are also pivoted such that the optical axes OA of the distance measuring devices are also running substantially parallel to the optical axis OL of the liquid lens 33 during a pivoting procedure.

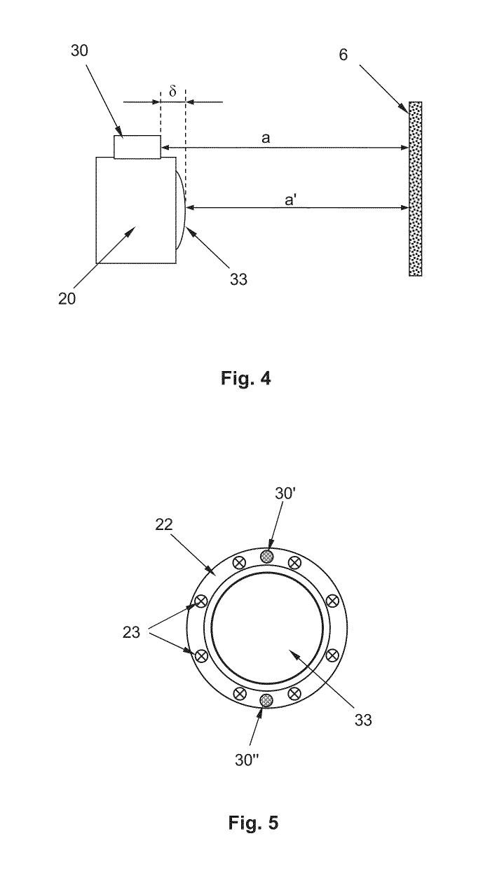

FIG. 4 shows a camera unit 20 according to the invention of an inspection system according to the invention with a focusing system according to the invention, whereby here, the liquid lens 33 and the distance measuring device 30 arranged at the camera head are shown.

The focus or the focal distance of the liquid lens 33, here, is adjusted or modified based on the measurement result of the distance measuring device 30. Here, the first distance a between the distance measuring device and an object 6, for example, the inner wall of the pipe of a sewer pipe, is measured by means of the distance measuring device 30. From the measured distance a, a distance a′ of the liquid lens 33 to the inner wall of the pipe 6 can be determined, if a horizontal offset δ between the distance measuring device 30 and the liquid lens 33 is known. Under consideration of the determined distance a′ between the liquid lens 33 and the inner wall of the pipe 6, the focus or the focal distance of the liquid lens 33 may be adjusted automatically correspondingly. Thereby, it is ensured that a sharp image of the object can also be provided, if the distance of the distance measuring device 30 to the object is larger due to a horizontal offset than the distance of the liquid lens 33 to this object.

FIG. 5 shows a camera unit according to the invention or a section thereof in a front view.

The camera unit comprises an illumination unit for illuminating the surroundings. The illumination unit, here, substantially consists of a ring being arranged around the liquid lens 33. At the ring, a number of illuminants 23, preferably light emitting diodes, are arranged. Further, in the embodiment shown in FIG. 5, at the ring, the first distance measuring device 30′ is arranged above the liquid lens 33 and the second distance measuring device 30″ is arranged below the liquid lens 33. According to this opposing arrangement of the two distance measuring devices 30′, 30″, it is ensured that the mean distance determined from the two distances almost corresponds to the distance between the liquid lens 33 and the object.

According to an embodiment of the invention, the ring or the illumination unit 22 may be arranged rotatably such that by rotating the ring, several distances between a distance measuring device arranged at the ring and an object may be measured, from which then, a mean distance can be determined.

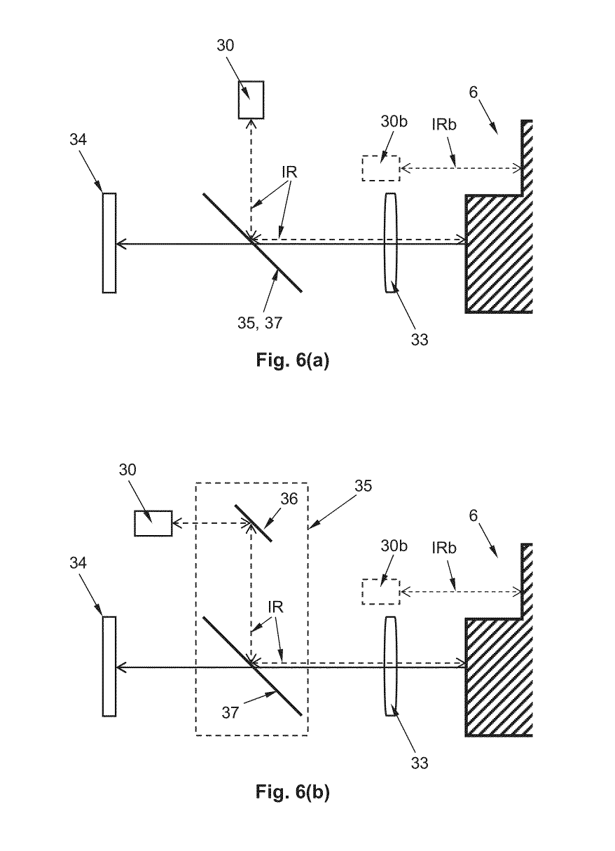

FIGS. 6(a) and 6(b) show two configurations of embodiments according to the invention of a focusing system 1 according to the invention.

According to the embodiments according to FIGS. 6(a) and 6(b), the focusing system comprises a deflecting means 35, by means of which the optical path of the distance measuring device 30 may be deflected such that it basically is directed coaxially with respect to the optical axis of the liquid lens 33 through the liquid lens 33.

Thereby, the actual distance of the liquid lens 33 to that point of the object 6 can be measured, which lies on the optical axis OL of the liquid lens 33.

With such an arrangement of the distance measuring device 30b relative to the liquid lens 33 that the optical path of the infrared rays IRb of the distance measuring device 30b basically runs parallel and spaced apart to the optical axis of the liquid lens 33, it may happen such that the distance between the distance measuring device 30b and the object 6 substantially differs from the distance between the liquid lens 33 and the object 6, as shown in FIG. 6 exemplary by the step which is present in the object 6. This may lead to an erroneous focusing.

By using a deflection means, as mentioned above, it is, however, ensured that the distance exactly to that point is measured, which lies on the optical axis OL of the liquid lens 33. Thereby, the focus or the focal distance of the liquid lens 33 can be adjusted even better or even more precise.

With respect to the embodiment of a deflection means 35 shown in FIG. 6(a), the latter comprises a beam splitter 37, for example, a semi-transparent mirror, which is arranged in the optical axis of the liquid lens 33, and which is inclined by a certain angle with respect to the optical axis of the liquid lens 33. The infrared rays IR emitted by the distance measuring device 30 are deflected by the beam splitter 27 such that the infrared rays thereafter are directed coaxially with respect to the optical axis of the liquid lens through the liquid lens 33. In reverse direction, the infrared rays reflected by the object 6 reach again the beam splitter 27, and are deflected by the latter to the distance measuring device 30. The visible light also reaches the beam splitter 37 through the liquid lens 33, where it at least partially passes through the latter, and hits the imaging means, for example, a CCD image sensor. A portion of the visible light, thereby, is deflected towards the distance measuring device 30, having, however, no influence on the distance measuring device. A portion of the infrared rays IR reflected by the object 6 passes through the beam splitter 37, and reaches the imaging means 34, also having no influence on the image taken. Instead of a CCD image sensor, also a CMOS image sensor or another sensor suitable for digital imaging may be provided.

In FIG. 6(b), an alternative configuration of a deflection means 35 of an embodiment of the inventive focusing system is shown. The deflection means 35, here, besides a beam splitter 37, also comprises a deflection mirror 36 arranged spaced apart from the beam splitter 37. The deflection mirror 36 is provided in order to deflect the infrared rays IR emitted by the distance measuring device 30 such that they hit the beams splitter 37 at a certain angle, and are deflected there such that they are directed substantially coaxially with respect to the optical axis of the liquid lens through the liquid lens.

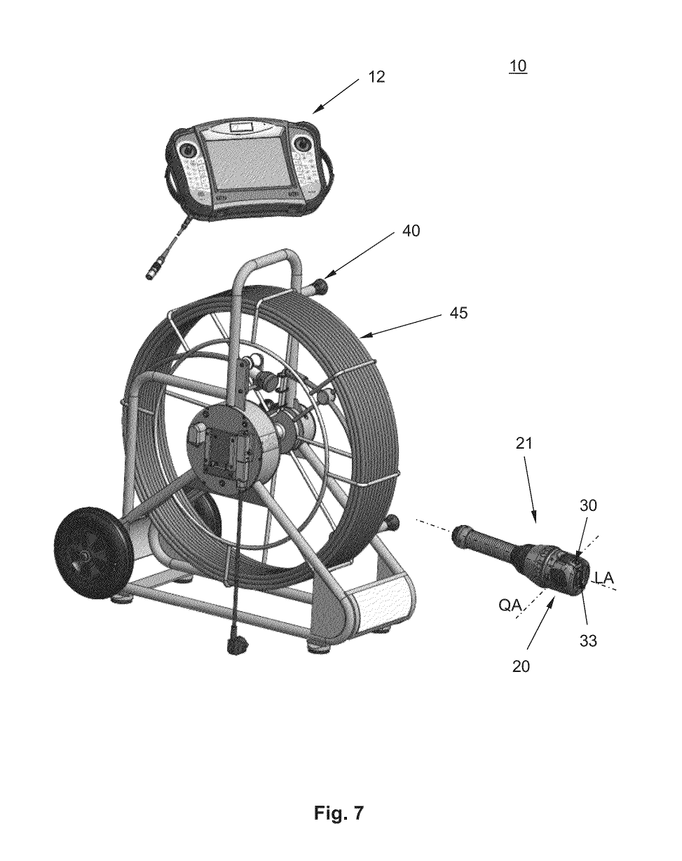

FIG. 7 shows a further concrete embodiment of an inventive inspection system 10. The inspection system 10, here, comprises a display and/or control unit 12, a coiler 40, on which a push rod 45 is wound, and a push unit 21, which comprises a camera unit 20 with an inventive focusing system. The push unit 21 is connected to an end of the push rod 45, the display and/or control means 12 is connected to the other end of the push rod 45. The push rod 45 has a certain rigidity in order to be able to push the push unit 21 into a pipe or a sewer. The push unit 21 is operatively coupled to the display and/or control unit 12 via the push rod 45. Thereby, measurement data, for example, image data of the push unit 21, may be transmitted to the display and/or control means 12, and vice versa, control data may be transmitted from the display and/or control unit 12 to the push unit 21. This inspection system, in particular, is characterized by the compact construction of the push unit 21 to be introduced into the pipe such that also pipes or conduits having a particularly small diameter can be inspected or checked.

In order to enable a particularly compact construction of the push unit 21, it is advantageous, if also the camera unit 20 may be configured as compact as possible. By the inventive focusing system, a specifically compact construction of the camera unit is enabled, because, in particular, a lens with a liquid lens is realizable in a particularly compact manner.

The push unit 21 and, in particular, the camera head or camera unit 20 arranged at the push unit with the focusing system arranged thereon are preferably configured fluid tight such that also moist pipes or pipes containing water can be inspected.

Because during advancing of the push unit 21 within a pipe, the push unit continuously moves, and thus, also the viewing direction of the camera unit continuously changes, it is important that the observed motive always is imaged sharply in spite of frequent movement. By the inventive focusing system, which enables the automatic adjustment or modification of the focal distance of the liquid lens in real time and depending on the distance between the liquid lens and the observed object, this is ensured.

An automatic adjustment or modification of the focus or the focal distance of the liquid lens in real time is, in particular, advantageous, if the camera unit or the push unit approaches an obstacle. Thereby, during approaching of the camera unit to the object, the latter is always imaged sharply.

According to an embodiment of the invention, it may be provided for the camera unit being switchable from an automatic focusing to a manual focusing. This may be, for example, advantageous, if details are to be focused, which are lying outside of the optical axis OL of the liquid lens.

A further advantage of the inventive focusing system is that due to the liquid lens being provided, a nearly wear-free focusing is enabled, substantially prolonging the life time of the focusing system. Further, the liquid lenses, which are used, are characterized by their shock resistance or vibration stability, being advantageous during use in rough surroundings, for example, in sewers containing water.

Above, the invention has been described by means of an inspection system for sewage pipes or sewage conduits. However, the implementation of the inventive inspection system is not limited to the inspection of sewage pipes or sewage conduits. Rather, by means of the inventive inspection system, also pipes or cavities of industrial plants or hardly accessible areas, for example, in nuclear plants or other buildings or plants can be inspected. For example, rotor blades of wind turbines can be inspected.

### REFERENCE NUMERALS

1 focusing system
5 pipe, e.g., sewage pipe
6 pipe wall or inner wall of the sewage pipe or object within the pipe
10 inspection system, in particular, pipe inspection system
12 display/control unit
15 inspection vehicle, e.g., camera vehicle
16 storage means and/or data processing means
18 transmission/receiver unit for wireless data transmission
20 camera head or camera unit
21 push unit with camera head (push camera)
22 illumination unit (e.g., LED ring)
23 illuminants (e.g., LED)
25 lifting unit of the inspection vehicle
30 distance measuring device
30′ first distance measuring device
30″ second distance measuring device
31 control means (e.g., microcontroller)
32 driver
33 liquid lens
34 imaging means (e.g., CCD image sensor)
35 deflection means
36 deflection mirror
37 beam splitter (e.g., semi-transparent mirror)
40 coiler
45 push rod
a distance between distance measuring device and object
a′ distance between lens or camera head and object
δ horizontal offset between distance measuring device and lens
IR infrared radiation
LA longitudinal axis of the inspection system or the camera head
OA optical axis of the distance measuring device 30
OL optical axis of the lens 33
QA transversal axis of the inspection vehicle

What is claimed is:

1. Focusing system for a camera unit of an inspection system, in particular, a pipe inspection system, comprising
a distance measuring device for measuring a distance to an object,
a control means operatively coupled to the distance measuring device,
and
an optical lens configured as liquid lens and operatively coupled to the
control means,
wherein the control means is adapted to adjust the focal distance of the liquid lens by means of the distance data received from the distance measuring device.

2. The focusing system of claim 1, wherein a driver circuit is arranged between the control means and the liquid lens, which is operatively coupled to the control means and to the liquid lens.

3. The focusing system of claim 1, wherein the distance measuring device comprises an optical distance measuring device.

4. The focusing system of claim 3, wherein the optical distance measuring device comprises an infrared distance measuring device having at least one infrared light emitting diode, and having at least one infrared photodiode, in particular, a multi-element photodiode or a lateral diode.

5. The focusing system of claim 1, wherein the distance measuring device is arranged with respect to the liquid lens such that the optical axis of the distance measuring device substantially runs parallel to the optical axis of the liquid lens.

6. The focusing system of claim 1, wherein the distance measuring device comprises a first distance measuring device and at least one second distance measuring device, wherein the at least one second distance measuring device is arranged spaced apart to the first distance measuring device, and wherein the optical axis of the first distance measuring device and the optical axis of the at least one second distance measuring device run substantially parallel to the optical axis of the liquid lens.

7. The focusing system of claim 6, wherein the control means is adapted to adjust the focal distance of the liquid lens on the basis of the distance data received from the first distance measuring device and from the at least one second distance measuring device.

8. The focusing system of claim 7, wherein the control means is adapted to determine a mean distance to the object from the distance data received from the first distance measuring device and from the at least one second distance measuring device, and to adjust the focal distance of the liquid lens on the basis of the mean distance.

9. The focusing system of claim 1, wherein the focusing system comprises a deflection means, which is adapted to deflect the optical path of the distance measuring device such that it is directed substantially co-axially to the optical axis of the liquid lens through the liquid lens.

10. The focusing system of claim 9, wherein the deflection means comprises a beam splitter, which is arranged in the optical axis of the liquid lens.

11. The focusing system of claim 9, wherein the deflection means comprises at least one deflection mirror.

12. The focusing system of claim 1, wherein the control means is adapted to adjust the focal distance of the liquid lens in real time.

13. The focusing system of claim 1, wherein the control means is adapted to take a horizontal offset between the liquid lens and the distance measuring device during adjustment of the focal distance of the liquid lens into account.

14. The focusing system of claim 1, wherein the focusing system is switchable from a manual operation mode into an automatic operation mode for adjusting the focal distance.

15. A camera unit for an inspection system, in particular, a pipe inspection system, comprising an imaging means and a focusing system according to claim 1 assigned to the imaging means.

16. The camera unit of claim 15, wherein the imaging means comprises a digital image sensor, in particular, a CCD image sensor or CMOS image sensor, and wherein an illumination unit is assigned to the camera unit.

17. The camera unit of claim 16, wherein the illumination unit comprises a number of illuminants, in particular, light emitting diodes, which are arranged radially around the liquid lens of the focusing system.

18. The camera unit of claim 16, wherein the illumination unit comprises a ring, on which the illuminants are arranged, and wherein the distance measuring device is arranged at the ring.

19. The camera unit of claim 15, wherein the camera unit comprises a storage or data processing means, or may be coupled to a storage or data processing means for storing or buffering the images taken by the camera unit, wherein detection means are assigned to the camera unit for detecting, if data can be transmitted between the camera unit and an external control unit, wherein the detection means are adapted to signalize to the control means that no data can be transmitted between the camera unit and the external control unit, and wherein the control means is adapted to switch into an automatic operation mode for adjusting the focal distance of the liquid lens, if no data can be transmitted, and wherein the camera unit is adapted to store the images taken in the storage and/or data processing means, if no data can be transmitted.

20. An inspection system comprising a camera unit according to claim 15.

21. The inspection system of claim 20, wherein the camera unit is arranged pivotably on a crawler of the inspection system, or on a push unit of the inspection system.
